(19) United States
(12) Patent Application Publication
(10) Pub. No.: US 2011/0079336 A1
(43) Pub. Date: Apr. 7, 2011

(54) Puncture-Resistant Device for a Non-Pneumatic Mounted Assembly of a Two-Wheeled Vehicle, and This Mounted Assembly Incorporating Same

(75) Inventors: Yannick Thenault, Montreuil Juigne (FR); Stéphane Riviere, Pannes (FR); Eric Gassaud, Amilly (FR)

(73) Assignee: Hutchinson

(21) Appl. No.: 12/899,121

(22) Filed: Oct. 6, 2010

(30) Foreign Application Priority Data
Oct. 6, 2009 (FR) 09 04762

(51) Int. Cl. B60C 19/12

(52) U.S. Cl. 152/311

(57) ABSTRACT

The present invention relates to a puncture-resistant device for a non-pneumatic mounted assembly of a two-wheeled vehicle, in particular for a bicycle, and to such a mounted assembly incorporating this device. The invention applies to a mounted assembly with no inflation pressure, the tire of which is permanently supported by this puncture-resistant device.

This puncture-resistant device (30) comprises an annular support (30), which is intended to be mounted between a rim (10) and a tire (20) of this mounted assembly (1) so as to permanently support this tire and which is constituted of a crosslinked rubber composition of cellular type having closed cells, the composition being based on at least one elastomer and comprising a reinforcing inorganic filler and at least one organic blowing agent.

According to the invention, said composition comprises at least one active grade zinc oxide capable of activating the thermal decomposition of said blowing agent so as to stabilize the expansion of the support by giving it a minimized average density.

### FIELD OF THE INVENTION

The present invention relates to a puncture-resistant device for a non-pneumatic mounted assembly of a two-wheeled vehicle, in particular for a bicycle, and to such a mounted assembly incorporating this device. The invention applies to a mounted assembly with no inflation pressure (i.e. with no pressurized gas such as air), the tire of which is permanently supported by this puncture-resistant device.

### BACKGROUND OF THE INVENTION

In a known manner, mounted assemblies for bicycles may incorporate means of pressurizing their internal space, whether this is via air chambers provided between the tire and the wheel rim (such a mounted assembly is then referred to as a “tube-type” mounted assembly) or else with no air chamber via the leaktight mounting of the tire against the rim flanges (“tubeless” mounted assembly).

One drawback of these pressurized mounted assemblies lies not only in the regular inflation that they require in order to overcome the gradual leakage of the inflation gas, but also in the fact that they can be perforated, for example by a puncture or by vandalism, which usually leads to the immobilization of the vehicle for the repairing thereof.

It is also known to use non-pneumatic tires (i.e. tires that do not require pressurization of the space within the tire) which form a tread for the mounted assembly and which are supported by a self-supporting elastomer support of cellular type having closed cells that substantially fills all the space between the tire and the rim. Mention may be made, for example, of document EP-B1-1 772 292 for the description of such a non-pneumatic mounted assembly for a bicycle, in which the support is based on a polyurethane elastomer.

One major drawback of these existing non-pneumatic mounted assemblies having cellular supports lies in their relatively high rolling resistance and/or in the road holding that leaves something to be desired which they give the bicycle that is equipped therewith (especially on a wet road). Other drawbacks of these non-pneumatic mounted assemblies lie in their relatively high mass and/or in their limited service life.

### SUMMARY OF THE INVENTION

One objective of the present invention is to propose a puncture-resistant device for a non-pneumatic mounted assembly of a two-wheeled vehicle, in particular of a bicycle, which makes it possible to overcome these drawbacks, this device comprising an annular support which is intended to be mounted between a rim and a tire of this mounted assembly so as to permanently support this tire and which is constituted of a crosslinked rubber composition of cellular type having closed cells, this composition being based on at least one elastomer and comprising a reinforcing inorganic filler and at least one organic blowing agent.

For this purpose, a device according to the invention is such that said composition comprises at least one active grade zinc oxide capable of activating the thermal decomposition of said blowing agent so as to stabilize the expansion of the support by giving it a minimized average density.

It will be noted that the Applicant has discovered that this zinc oxide specifically of active grade (which differs from the zinc oxides commonly used in rubber manufacture for activating the crosslinking of the elastomer by a value of the BET specific surface area which is much higher with a narrow tolerance on both sides of this value, as explained below) has the effect of modifying the thermal decomposition temperature of the blowing agent which is at the origin of the release of a gas during the heating that produces the expansion of the composition, which surprisingly makes it possible to optimize this expansion in order to obtain a reduced average density thereof in the expanded state.

More specifically, said support may thus advantageously have an average density between 400 and 800 kg/m³ and preferably between 500 and 700 kg/m³, which is particularly suitable for the mounted assemblies of bicycles. More advantageously still, this support may have a density gradient between a central support zone of maximum density and a peripheral support zone of minimum density.

Thus, improved dynamic performances of the crosslinked and expanded support are obtained, in particular with a minimized rolling resistance during the service life of the support. Furthermore, this service life of the support is increased relative to that of the known cellular supports made of polyurethane, as are the comfort and road-holding features conferred by this support on the vehicle.

Advantageously, said at least one elastomer used in a support according to the invention is chosen from the group consisting of ethylene-propylene copolymers (EPM) and diene elastomers. More advantageously still, said at least one elastomer may be chosen from the group consisting of ethylene-propylene copolymers (EPM), ethylene-propylene-diene terpolymers (EPDM), natural rubber (NR), polyisoprenes (IR), nitrile rubbers (NBR), polybutadienes (BR) and styrene-butadiene copolymers (SBR).

Preferably, said composition is based on an elastomer matrix which is predominantly or, more preferably still, exclusively constituted of an EPDM elastomer, which preferably has a content of units derived from ethylene between 55% and 65% and a content of units derived from ethylidene norbornene (ENB) between 5% and 15%.

As a variant, it is conceivable to use a blend of such an EPDM with another elastomer also of apolar nature and having a solubility coefficient close to that of the EPDM used, such as for example a diene elastomer of natural rubber (NR), polyisoprene (IR), polybutadiene (BR), styrene-butadiene copolymer (SBR) or isoprene-isobutylene copolymer (IIR, also known as butyl rubber) type, provided that the elastomer matrix of the composition is based on this EPDM (the expression “based on” is understood here to mean predominantly constituted of, i.e. in a weight fraction greater than 50% and preferably greater than 75%).

The expression “reinforcing inorganic filler” is understood in the present description to mean a group of clear fillers other than carbon black, such as chalk and kaolin which are preferably used in the composition of the invention. Advantageously, the weight fraction of all of these clear fillers in the composition may be between 25 and 35%.

It will be noted that the composition of the invention may also include carbon black in addition to this reinforcing inorganic filler, advantageously in a weight fraction between 5 and 9%. This carbon black which can thus optionally be used in combination with the aforementioned clear fillers, such as chalk and kaolin, may make it possible to improve, on the one hand, the bearing capacity (or load-bearing strength when rolling) of the support and, on the other hand, its tensile strength. It is nevertheless possible to consider that the absence of carbon black could improve the compression set of the support, which means that, as a function of the desired compromise of performances, it is possible to adjust, to a certain extent, the amount of carbon black in the composition.

Preferably, said zinc oxide of active grade has a BET specific surface area greater than or equal to 30 m²/g and a tolerance of less than ±5 m²/g, this specific surface area preferably being between 40 m²/g and 45 m²/g with a tolerance of less than ±3 m²/g. This BET surface area is conventionally measured according to the Brunauer-Emmett-Teller method described in “The Journal of the American Chemical Society”, Vol. 60, page 309, February 1938 and that corresponds to the AFNOR-NFT-45007 standard of November 1987.

Indeed, the Applicant has established that it is this extremely reduced tolerance with respect to the specific surface area of this active grade zinc oxide which makes it capable of fulfilling the aforementioned role of activating and stabilizing the expansion.

Equally preferably, this active grade zinc oxide is present in the composition in a weight fraction between 1% and 5%.

Advantageously, said at least one blowing agent may be an azodicarbonamide present in said composition in a weight fraction between 2% and 6%.

Equally advantageously, said composition also may comprise reinforcing textile fibers preferably based on a polyamide, these fibers being present in said composition in a weight fraction between 0.5% and 1.5%.

It will be noted that these fibers have a role of a structural agent which reinforces the mechanical characteristics of the support in order to optimize the durability thereof.

According to another feature of the invention, said composition contains, besides said elastomer matrix, said blowing agent(s), said inorganic reinforcing filler and optionally said organic reinforcing filler and/or said fibers, and said active zinc oxide:

a crosslinking system which is preferably a sulfur vulcanization system comprising at least one vulcanization accelerator, the weight fraction of such a vulcanization system in the composition advantageously being between 1 and 3%, and

all or some of the other additives customarily used in rubber compounds, such as for example extender oils, plasticizers, pigments, antioxidants, and processing aids.

It will be noted that said active grade zinc oxide used as an activator for the decomposition of the blowing agent also makes it possible to activate the crosslinking of the elastomer used.

According to another feature of the invention, the puncture-resistant device may be exclusively constituted of said elastomer support, which has a substantially toroidal shape that is solid or hollowed out circumferentially.

A non-pneumatic mounted assembly according to the invention for a two-wheeled vehicle, in particular for a bicycle, comprises a wheel rim, a tire of compact (i.e. non-cellular) elastomer type comprising a tread and two beads mounted against two flanges of the rim and, a puncture-resistant device as defined above which is mounted between this rim and this tire, this mounted assembly being free of any means of pressurizing its internal space.

According to another feature of the invention, the support may be mounted around the rim and in contact with the tire occupying substantially all the space within the latter, the support optionally following the profile of the base of the rim axially between said rim flanges.

It will be noted that the support of the invention may optionally have a relatively rough or grainy surface appearance, so that the friction coefficient between the support and the tire which it supports is sufficient to prevent the displacement of the support inside the tire and to thus help to maintain the dynamic performance of the mounted assembly.

A mounted assembly according to the invention has, in particular, the following advantages, in addition to those cited above:

effective protection against the risks of puncture of the tire by perforation, impact/pinching when rolling or vandalism, for example;

bearing capacity and rolling of the vehicle provided under satisfactory conditions, with a weight which is only slightly increased relative to the current pneumatic mounted assemblies which use a pressurized gas and which is reduced relative to the existing non-pneumatic mounted assemblies;

the rolling resistance continues to be maintained at a relatively low level;

satisfactory comfort, road-holding and service-life qualities for the user; and

very simple mounting of the support inside the tire, with no particular tool other than standard “tire levers”.

### BRIEF DESCRIPTION OF THE DRAWINGS

Other features, advantages and details of the present invention will emerge on reading the following description of several exemplary embodiments of the invention, given by way of illustration and non-limitingly, said description being given in reference to the appended drawing, in which:

FIG. 1 is a schematic view in axial half-section of a non-pneumatic mounted assembly for a bicycle according to a first example of the invention, in which the support does not follow the base of the rim,

FIG. 2 is a schematic view in axial half-section of a non-pneumatic mounted assembly for a bicycle according to a second example of the invention, in which the support follows this rim base; and

FIG. 3 is a view in axial half-section of a non-pneumatic mounted assembly for a bicycle according to a third example of the invention corresponding to a variant of FIG. 1.

### DETAILED DESCRIPTION

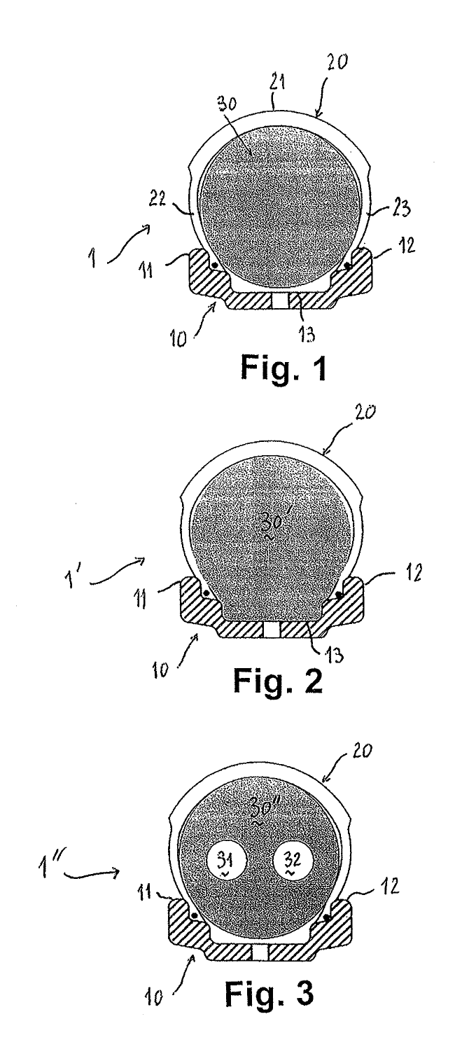

The mounted assembly 1 from FIG. 1 comprises:

a wheel rim 10 having two rim seats which end with two flanges 11 and 12 of this rim and which between them axially delimit a rim base 13;

a tire 20 based on at least one compact elastomer comprising a tread 21 and two side walls 22 and 23 that respectively end with two beads reinforced by two bead wires, which beads are mounted on these two seats (the various plies or reinforcements that reinforce this tire 20 are not represented); and

a crosslinked and expanded puncture-resistant support 30 mounted between the rim 10 and the tire 20 and supporting the latter, the support 30 having a substantially circular cross section (after extrusion in the form of a rectilinear “rod”, followed by its continuous crosslinking/expansion then a butt joining of its ends in order to give it an annular geometry).

According to the invention, this support 30 is self-supporting in the sense that it is sufficient to provide the load-bearing capacity, when rolling, of the tire 20 without the use of an inflation gas in the cavity delimited by the latter around the rim 10.

The puncture-resistant support 30′ of the mounted assembly l′ from FIG. 2 only differs from that of FIG. 1 in that it has a truncated cross section in order to follow the profile of the rim base 13 by wedging itself therein between the rim seats. In the example from FIG. 2, the support 30′ has a wedging portion of overall rectangular axial cross section.

The puncture-resistant support 30″ of the mounted assembly 1″ from FIG. 3 only differs from that of FIG. 1 in that it has two circumferential channels 31 and 32, parallel to one another, of the same circular axial cross section and, in this example, both arranged at a same radial height relative to the rim 10, axially on both sides of the central axis of symmetry of the substantially toric support 30″. These channels 31 and 32 are especially designed to lighten the mounted assembly, it being specified that a different number thereof could, as a variant, be provided (for example a single central hollowing out) with a different position within the support and/or with non-circular axial cross sections.

An example for manufacturing a support 30 according to the invention will now be described, given by way of illustration with reference to the example from FIG. 1.

In a first step of thermomechanical working, mixing of a rubber composition corresponding to the following formulation was carried out (the amounts are expressed as weight fractions):

30% of an EPDM elastomer with 58% of units derived from ethylene, 33% of units derived from propylene and 9% of units derived from ethylidene norbornene (ENB);

7% of carbon black;

29% of a reinforcing inorganic filler comprising a mixture of chalk and kaolin;

3% of active grade ZnO in powder form having a BET specific surface area equal to 42.5±2.5 m²/g;

15% of a liquid paraffin;

4% of a blowing agent constituted of azodicarbonamide;

6% of a thermoplastic polymer of polyolefin type;

3% of processing aids and additives, comprising polyethylene glycol, stearic acid and calcium oxide;

2% of a sulfur crosslinking system; and

1% of fibers of a polyamide as a structural agent.

In a second shaping step, the rubber composition obtained at the end of the first step was extruded in order to obtain a crosslinkable and expandable support preform, in the form of an extruded rectilinear “rod” having, for example, an overall toric cross section.

Following a third step of crosslinking/expansion carried out continuously in contact with hot air in an oven, a crosslinked and expanded extrudate was obtained that was subjected to a cooling operation, then cut into portions having a length corresponding to the circumference of the rim 10.

The two ends of each portion were then finally butt-joined together in order to mount each support 30 thus obtained inside the tire 20 and around the rim 10. Each support 30 had, in this example, an external diameter around 33 mm, and an average density of only 600 kg/m³.

1. Puncture-resistant device for a non-pneumatic mounted assembly of a two-wheeled vehicle, in particular of a bicycle, this device comprising an annular support which is configured to be mounted between a rim and a tire of this mounted assembly so as to permanently support this tire and which comprises a crosslinked rubber composition of cellular type with closed cells, said composition being based on at least one elastomer and comprising a reinforcing inorganic filler and at least one organic blowing agent, characterized in that said composition comprises at least one active grade zinc oxide capable of activating the thermal decomposition of said blowing agent so as to stabilize the expansion of the support by giving it a minimized average density.

2. Puncture-resistant device according to claim 1, characterized in that said support has an average density between 400 kg/m³ and 800 kg/m³.

3. Puncture-resistant device according to claim 1, characterized in that said support has a density gradient between a central support zone of maximum density and a peripheral support zone of minimum density.

4. Puncture-resistant device according to claim 1, characterized in that said zinc oxide of active grade has a BET specific surface area greater than or equal to 30 m²/g and a tolerance of less than ±5 m²/g, this specific surface area being between 40 m²/g and 45 m²/g with a tolerance of less than ±3 m²/g.

5. Puncture-resistant device according to claim 1, characterized in that said active grade zinc oxide is present in said composition in a weight fraction between 1% and 5%.

6. Puncture-resistant device according to claim 1, characterized in that said reinforcing inorganic filler comprises chalk and kaolin, in a total weight fraction in said composition between 25% and 35%.

7. Puncture-resistant device according to claim 1, characterized in that said composition also comprises a sulfur crosslinking system a weight fraction between 1% and 3%.

8. Puncture-resistant device according to claim 1, characterized in that said at least one elastomer is selected from the group consisting of ethylene-propylene copolymers (EPM) and diene elastomers.

9. Puncture-resistant device according to claim 8, characterized in that said at least one elastomer is selected from the group consisting of ethylene-propylene copolymers (EPM), ethylene-propylene-diene terpolymers (EPDM), natural rubber (NR), polyisoprenes (IR), nitrile rubbers (NBR), polybutadienes (BR) and styrene-butadiene copolymers (SBR).

10. Puncture-resistant device according to claim 9, characterized in that said composition is based on an elastomer matrix which is predominantly or exclusively constituted of an EPDM elastomer,

11. Puncture-resistant device according to claim 11, wherein said EPDM elastomer has a content of units derived from ethylene between 55% and 65% and a content of units derived from ethylidene norbornene (ENB) between 5% and 15%.

12. Puncture-resistant device according to claim 1, characterized in that said composition also comprises structural reinforcement textile fibers based on a polyamide, said fibers being present in said composition in a weight fraction between 0.5% and 1.5%.

13. Puncture-resistant device according to claim 1, characterized in that said device is constituted of said elastomeric support, which has a substantially toroidal shape that is solid or hollowed out circumferentially.

14. Non-pneumatic mounted assembly for a two-wheeled vehicle comprising a wheel rim, a tire of compact elastomer type comprising a tread and two beads mounted against two flanges of the rim and a puncture-resistant device of claim 1 mounted between said rim and said tire, this mounted assembly being free of any means of pressurizing its internal space.

15. Non-pneumatic mounted assembly according to claim 14, wherein said two-wheeled vehicle is a bicycle.

16. Mounted assembly according to claim 14, characterized in that said support is mounted around the rim and in contact with the tire occupying substantially all the space within the latter, this support optionally following the profile of the base of the rim axially between said flanges.
